(19) United States
(12) Patent Application Publication
(10) Pub. No.: US 2008/0318592 A1
(43) Pub. Date: Dec. 25, 2008

(54) DELIVERING TELEPHONY COMMUNICATIONS TO DEVICES PROXIMATE TO A RECIPIENT AFTER AUTOMATICALLY DETERMINING THE RECIPIENT'S LOCATION

(75) Inventor: BAIJU D. MANDALIA, BOCA RATON, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/766,890

(22) Filed: Jun. 22, 2007

(51) Int. Cl. H04Q 7/20

(52) U.S. Cl. 455/456.1

(57) ABSTRACT

The present invention discloses a communication method and system, which can include a step of repetitively conveying presence information to a service provider to continuously update a current location of a person identified within the presence information. A communication attempt directed towards the person can be detected. A communication device proximate to the person can be determined based upon the presence information. The communication device can be accessible by any proximate individual. The communication device can be one not specifically designated by an originator of the communication attempt. A notification of the communication attempt can be presented in an environment proximate to the determined communication device. The communication can be established responsive to the person answering the notification by activating the communication device.

### BACKGROUND

1. Field of the Invention

The present invention relates to the field of telecommunications, more specifically to delivering telephony communications to devices proximate to a recipient after automatically determining the recipient's location.

2. Description of the Related Art

While mobile phones have made it possible to receive calls while traveling, there is still a gap in telecommunications coverage not satisfied by mobile telephones. For example, mobile phone users are generally unable to receive facsimile messages directed to them. Further, mobile phone communications can perform sporadically from area to area. When a mobile phone user is in an area that does not have cellular reception, the user may not receive calls. In some areas, such as airplanes, theaters, and the like, mobile phones must or should be turned off, making these areas approximately equivalent to those having no reception. In other areas, calls can be received but at a higher cost due to roaming charges from using non-native service provider networks. Also, areas exist where mobile calls can be received, but with diminished clarity than that achieved through a line based communication.

In areas where it is not favorable to use mobile phones, travelers have often relied on public access points, such as pay phones, to make phone calls. An availability of public access points or other line-based telephony devices has not historically helped travelers with incoming communications. It would be advantageous to travelers and other roaming individuals to be able to leverage proximate telephony devices to receive incoming communications.

### SUMMARY OF THE INVENTION

The present invention discloses a solution for delivering telephony communications to devices proximate to a recipient after automatically determining the recipient's location. In the solution, a user can carry a location determination device, generically referred to herein as a location beacon. In one embodiment, digital messages or signals from the location beacon can be wirelessly received by proximate telephony devices which transmit presence information concerning the user to a service provider. In another embodiment, a single mobile device, such as a GPS equipped phone, can be used to locate the user and to convey this information to a service provider. The service provider can maintain a database of user locations and proximate telephony devices.

When callers attempt to communicate with one of these users, the service provider can direct the call to a telephony device proximate to the intended recipient. In one embodiment, this feature can operate as a more dynamic variant of call-forwarding. An intended recipient can be informed of the incoming call in numerous ways, such as through a ringing of the telephony device, a generated speech message, a message appearing upon a nearby visual display, and the like. The intended recipient can answer the telephony device and utilize it to communicate with the caller.

The present invention can be implemented in accordance with numerous aspects consistent with the material presented herein. For example, one aspect of the present invention can include a communication method including a step where presence information associated with a target recipient is conveyed across a network to a data store. A communication request can be received from an originator directed towards a target recipient. A geographical location of a target recipient can be determined by querying the data store of presence information. An available communication device proximate to the geographical location can be ascertained. This device can have a device identifier not specified within the communication request. A communication can be initiated with the ascertained communication device. Responsive to the device being activated, a communication can be established between the ascertained device and the originator.

Another aspect of the present invention can include a communication system including a presence information data store and a communication service provider. The presence information data store can be continuously updated with information specifying an identity and a geographical location of multiple people. The presence information data store can store a set of device records indicating a location and a contact identifier for a set of communication devices. The communication service provider can accept communication attempts from an originator directed towards a target recipient. The service provider can also determine a geographical location of the target recipient by querying the presence information data store. A proximate communication device can be determined by comparing the device records against the determined geographical location. The service provider can send a communication initiation to the proximate communication device. A communication can be established between the originator and the proximate communication device once the communication initiation has been accepted.

Still another aspect of the present invention can include a communication method including a step of repetitively conveying presence information to a service provider to continuously update a current location of a person identified within the presence information. A communication attempt directed towards the person can be detected. A communication device proximate to the person can be determined based upon the presence information. The communication device can be accessible by any proximate individual. The communication device can be one not specifically designated by an originator of the communication attempt. A notification of the communication attempt can be presented in an environment proximate to the determined communication device. The communication can be established responsive to the person answering the notification by activating the communication device.

It should be noted that various aspects of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

It should also be noted that the methods detailed herein can also be methods performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a system for telecommunications delivery to a proximate device via proximity detection in accordance with the embodiment of inventive arrangements disclosed herein.

FIG. 2 is a flowchart illustrating a method for telecommunications delivery to a proximate device via proximity detection in accordance with the embodiment of inventive arrangements disclosed herein.

FIG. 3 is a schematic diagram illustrating a system for telecommunications delivery to a proximate device via proximity detection in accordance with the embodiment of inventive arrangements disclosed herein.

FIG. 4 is a schematic diagram illustrating a system for telecommunications delivery to a proximate device via proximity detection in accordance with the embodiment of inventive arrangements disclosed herein.

### DETAILED DESCRIPTION OF THE INVENTION

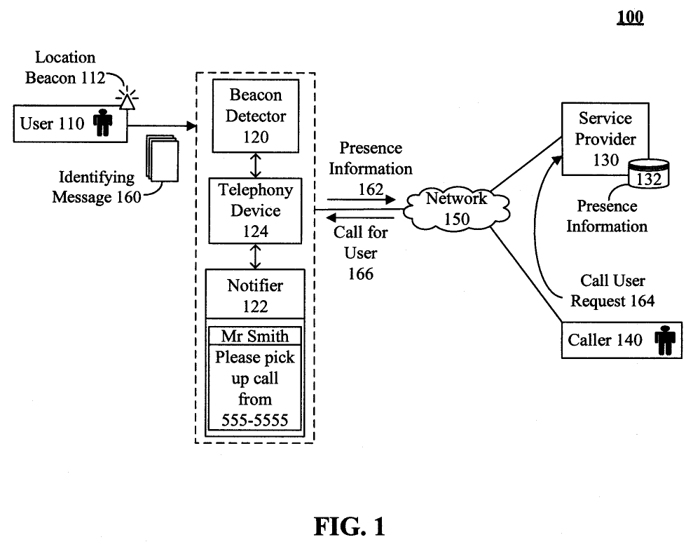

FIG. 1 is a schematic diagram illustrating a system 100 for telecommunications delivery to a proximate device via proximity detection in accordance with the embodiment of inventive arrangements disclosed herein. In system 100, a user 110 can be associated with a location beacon 112, which sends an identifying message 160 to a beacon detector 120. Beacon detector 120 processes the message 160 to determine a user identity and a user location. In one embodiment, the detector 120 can be in a known location, which is used to triangulate or otherwise determine the user location. After processing, presence information 162 indicating the user 110 and his/her location is conveyed though a telephony device 124 or other network element over network 150 to service provider 130. The service provider 130 can manage the presence information in a data store 132, which also tracks locations of one or more telephony devices 124. As a user 110 moves, his/her location dynamically changes, which results in updates (new presence information 162) continuously being received by the service provider 130, which updates data store 132 appropriately.

A caller 140 can contact the service provider 130 with a call request 164 directed towards user 110. A setting maintained by provider 130 can indicate that calls for user 110 are to be directed to telephony devices 124 proximate to the user 110. After consulting data store 132, the provider 130 can determine at least one proximate telephony device 124 to which the call from caller 140 is to be directed. The provider 130 can issue a call 166 for the user 110. A notifier 122 linked to the telephony device 124 can inform the user 110 of the incoming communication. The user 110 can utilize the telephony device 124 to engage in the telephony communication.

It should be noted that the system 100 is not limited to handling voice-based telephone communications, but can also be used to handle facsimile messages, dispatch communications (two-way radio), video teleconferencing, chat communications, text-messages, email, and the like. Further, different communicators (user 110 and caller 140) can utilize different communication modalities (e.g., user 110 uses text messaging modality and caller 140 uses a voice modality), which are dynamically converted as necessary by a converter (not shown).

In one embodiment, security measurements can be incorporated into system 100, such as only permitting communications while the identification beacon 112 is within X feet of the telephony device 124, which can prevent unintended recipients from engaging in the caller 140 initiated communication. Biometric identification with device 124 and/or use of a passcode can also be used for enhancing security.

As used in system 100, an identification beacon 112 can include passive, semi-active, and active mechanisms used to ascertain locations and/or information about an associated device or user 110. A location beacon 112 can internally determine a location of the user 110 or can be used in conjunction with one or more detectors 120 to determine a location. Location beacons 112 can include Radio Frequency Identification (RFID) tags, Global Positioning System (GPS) transceivers, BLUETOOTH transceivers, WIFI transceivers, and other such devices.

For example, the location beacon 112 can include an RFID tag embedded within a device commonly carried by user 110, such as a user's name tag, a parking pass, a keychain, a wallet card, a driver's license, and the like. RFID scanners (beacon detectors 120) can be strategically positioned so that locations of user 110 carried RFID tags can be automatically determined. Additionally, information embedded within the RFID tags (message 160) can be used to specify data about the user 110.

The use of other types of beacons 112 is contemplated herein. For example, a short distance transceiver can be used as a beacon 112. Short distance transceivers include BLUETOOTH transceivers, cellular transceivers, and wireless network transceivers (802.11 compliant protocols). Beacon detectors 120 can include BLUETOOTH servers, cellular towers, wireless access points, and the like. A distance of a beacon 112 to an access point (detector 120) can be determined based in part upon signal strength. A position of the beacon 112 can also be triangulated based upon wireless signals received from multiple sensors.

The telephony device 124 can be any computing device capable of receiving communications from caller 140, which are handled by the service provider 130. The telephony device 124 can be a line-based phone, a mobile telephone, a two-way radio, a facsimile machine, a computer, a kiosk, an email station, and other such devices.

The notifier 122 can be any device configured to notify the user 110 of an incoming communication. The notifier 122 can include an audio transceiver and/or a visual display. In one embodiment, the notifier 122 can be a wireless device, such as a BLUETOOTH headset, that is communicatively linked to the telephony device 124 and which can be used to communicate with the device 124. The notifier 122 can operate in a characteristic manner to inform the user 110 that a call is intended for them and/or can provide additional call information useful for the user. For example, the notifier 122 can inform user 110 that a call for them from a phone number 555-5555 is being conveyed to a proximate device 124.

In one embodiment, a characteristic ring tone can be configured by the user 110 and used by the notifier 122 so that a user 110 is able to discriminate from calls directed toward the user 110 and those directed towards others. In another embodiment, speech synthesizing technologies can also be used by the notifier 122 to provide descriptive notifications. Similarly, the notifier can combine a visually displayed message with a device 124 identifier to assist user 110 in knowing which device 124 should be used to answer an incoming call. For example, a message of “Mr. Smith, please answer the phone blinking red to receive a call from Mr. Jones” can be presented on the notifier 122, where a blinking red light is activated on a nearby device 124.

The service provider 130 can be a carrier who provides a communication service to user 110 and/or caller 140. For example, the service provider 130 can be a telecommunications carrier that provides telephone service to user 110 and/or caller 140. The presence information 132 can be maintained by the service provider 130 itself, or can be independently maintained for use by the service provider 130 by a separate entity cooperating with the service provider 130. In one embodiment, the proximity routing features of system 100 can be implemented within a middleware solution, which is utilized by a carrier connecting caller 140 to user 110.

Network 150 can include any hardware/software/and firmware necessary to convey digital content encoded within carrier waves. Content can be contained within analog or digital signals and conveyed through data or voice channels and can be conveyed over a personal area network (PAN) or a wide area network (WAN). The network 150 can include local components and data pathways necessary for communications to be exchanged among computing device components and between integrated device components and peripheral devices. The network 150 can also include network equipment, such as routers, data lines, hubs, and intermediary servers which together form a packet-based network, such as the Internet or an intranet. The network 150 can further include circuit-based communication components and mobile communication components, such as telephony switches, modems, cellular communication towers, and the like. The network 150 can include line based and/or wireless communication pathways.

Data store 130 can be physically implemented within any type of hardware including, but not limited to, a magnetic disk, an optical disk, a semiconductor memory, a digitally encoded plastic memory, a holographic memory, or any other recording medium. The data store 130 can be a stand-alone storage unit as well as a storage unit formed from a plurality of physical devices, which may be remotely located from one another. Additionally, information can be stored within each data store in a variety of manners. For example, information can be stored within a database structure or can be stored within one or more files of a file storage system, where each file may or may not be indexed for information searching purposes.

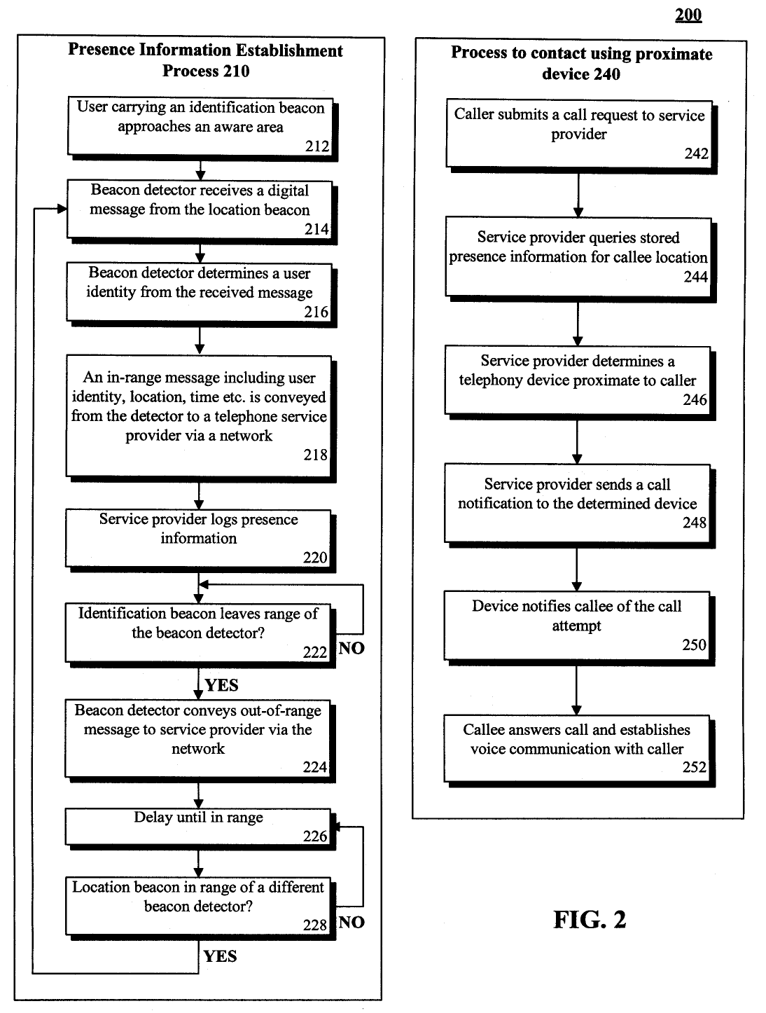

FIG. 2 is a flowchart illustrating a method 200 for telecommunications delivery to a proximate device via proximity detection in accordance with the embodiment of inventive arrangements disclosed herein. Method 200 includes a presence information establishment process 210 and a process 240 to contact a communication recipient via a proximate device. Method 200 can be performed in the context of system 100 or any system permitting incoming communications to be directed to devices proximate to intended recipients.

In the presence information establishment process 210, a user carrying an identification beacon can approach a location aware area as illustrated in step 212. In step 214, a beacon detector can receive a digital message from the location beacon. Beacon can determine a user identity from the received message from step 214, as shown in step 216. In step 218, an in-range message including user identity location, time, etc., can be conveyed from the detector to a telephone service provider via a network. In step 220, the telephone service provider can store the presence information.

If a beacon detector detects the identification beacon is no longer in range, then the method can proceed from step 222 to step 224, else the method can return to step 222. In step 224, the beacon detector conveys out-of-range message to service provider via the network. Presence information acquisition and updates can be delayed until the identification beacon is in range, as illustrated in step 226. In step 228, the identification beacon can be in range of a different beacon detector. In the determining step 228, the method can return to step 214, else return to step 226.

The process 240 can begin in step 242, where a caller can submit a call request to service provider. The call request can be to a designated phone number or to a target recipient without specifying a phone number. When only a target recipient is specified in the call request, the service provider must determine the phone number (or communication address, such as a URL, if the end device is not associated with a phone number) for the target recipient. When a phone number (or other communication address) is provided, the call request can be forwarded by the service provider to another phone number (or other communication address), which can be dynamically determined based upon a recipient location.

In step 244, the service provider can query stored presence information for a recipient location. That provider can determine a telephone device proximate to the target recipient, as shown in step 246. In step 248, the service provider can convey a call notification to a notifier associated with the determined telephone device. In step 250, the target recipient can be notified of the call attempt. In step 252, the target recipient can answer the call and establish a communication, voice or otherwise, with the caller.

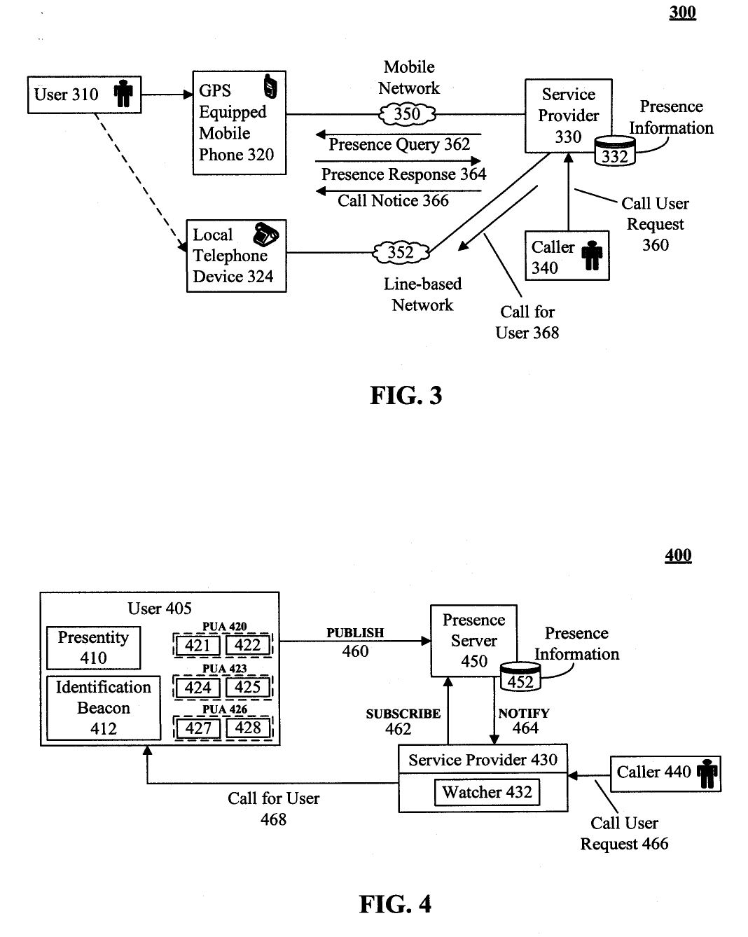

FIG. 3 is a schematic diagram illustrating a system 300 for telecommunications delivery to a proximate device via proximity detection in accordance with the embodiment of inventive arrangements disclosed herein. System 300 illustrates an embodiment of the system 100, where a location detection device is integrated into a mobile communication device (320). A configurable setting of device 320 can cause calls directed to phone 320 to be forwarded to proximate line-based device 324 when available.

System 300 also shows a reactive mechanism (pull based) for receiving presence information as opposed to a proactive mechanism (push based) shown in system 100. The reactive and/or proactive mechanisms can be substituted for each other in either system 100 or 300.

In system 300, caller 340 can place 360 a call to user 310 through service provider 330. Service provider 330 can obtain presence information 332 from user 310 via GPS equipped mobile phone 320. Service provider 330 can perform presence query 362 to obtain presence information for user 310 via mobile network 350. GPS equipped mobile phone 320 can respond to presence query 362 with a presence response 364. Presence response 364 can be used to identify and locate user 310.

Service provider 330 can provide notification 366 of incoming call to user 310. GPS equipped mobile phone 320 can receive call notice 366. The notice 366 can inform the user 310 that an incoming call is being directed towards device 324. In one embodiment, the user 310 can opt to have the call relayed to the mobile device 320 instead of the proximate device 324 at this point.

It should be emphasized that system 300 illustrates more than a variant of a roaming technology for a mobile phone 320. The phone 320 is being used for its location determination and/or notification capabilities and not necessarily for telephony communications.

For example, presence 364 and/or notification 366 data is able to be conveyed over a data channel of network 350, which is available even when a signal strength of phone 320 is too weak to support voice communications, yet is strong enough to support low bit rate or short message service communications. That is, voice communications require sufficient bandwidth of a consistent connection to convey real-time audio bi-directionally (or uni-directionally in the case of two-way radio communications). The local, fixed position, communication device 324 can enable clear voice quality communications between user 310 and caller 340, even when clear voice quality communications are unavailable via mobile phone 320. The device 324 can also include capabilities outside those of a typical mobile phone 320. For example, device 324 can be a facsimile machine able to receive and print a fax conveyed from caller 340 to user 310.

Assuming the call is to be directed to the local device 324, an incoming call (or other communication) for user 368 can be routed through land based network 352. User 310 can answer the call and communicate with caller 340 (or receive the communication) via local telephone device 324.

FIG. 4 is a schematic diagram illustrating a system 400 for telecommunications delivery to a proximate device via proximity detection in accordance with the embodiment of inventive arrangements disclosed herein. System 400 represents an embodiment of system 100, where open standards are used for handling presence information. For example, presence information can be conveyed using Session Initiation Protocol (SIP) based messages in conformance with an Internet Engineering Task Force (IETF) based standard. Further, presence information can be written in a presence information data format (PIDF) and/or rich presence information data (RPID).

In system 400, presence server 450 can manage and distribute presence information 452. A service provider 430 can use a watcher 432 to obtain presence information from the presence server 450. Watcher 432 can SUBSCRIBE 462 to presence information for a particular presentity (user 405). The subscription permits the watcher 432 to obtain continuously updated presence information through received notifications 464.

The user 405 can carry an identification beacon 412 used to track his/her position. The user 405 can be referred to as a presentity 410. The user can utilize one or more presence user agents (PUAs) 420, 423, 426, which are communication devices capable of PUBLISHING 460 presence information to the server 450.

Each PUA 420, 423, 426 can include a beacon detector 421, 424, 427 configured to acquire and process information from the identification beacon 412, whenever the user 405 is nearby. Each PUA 420, 423, 426 can include a communication component 422, 425, 428 as well as a notifier (not shown).

In system 400, a caller 440 can convey call request 466 to the service provider 430. The service provider can determine a location of an intended recipient, which is associated with watcher 432. After determining a recipient location, a proximate communication device can be determined. The provider 430 can convey a call notification to this device, which the user 405 can answer, which establishes the communication between caller 440 and user 405.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A communication method permitting a communicator to utilize a proximate, location-fixed communication device, said method comprising:
conveying presence information associated with a target recipient across a network to a data store;
receiving a communication request from an originator to a target recipient;
determining a geographical location of a target recipient by querying the data store of presence information;
ascertaining at least one available communication device proximate to the geographical location, wherein the ascertained communication device is not associated with a device identifier specified within the communication request;
initiating a communication with the ascertained communication device; and
responsive to an activation of the ascertained communication device, establishing a communication between the ascertained communication device and the originator.

2. The method of claim 1, further comprising:
wirelessly sending an identifying message from an identifying beacon to a beacon detector; and
processing the identifying message to determine a user identity and a location, wherein the presence information comprises the user identity and the location.

3. The method of claim 2, further comprising:
continuously performing the conveying, processing, and sending steps as an individual carrying the identifying beacon moves from one location to another to assure the presence information used to ascertain the proximate communication device is current.

4. The method of claim 2, wherein the identifying beacon is a radio frequency identification (RFID) tag.

5. The method of claim 1, further comprising:
a location detection component of a mobile device carried by the target recipient determining a location of the target recipient;
generating a message including the determined location and an identity of the target recipient, wherein the presence information comprises the generated message; and
continuously repeating the step of determining the location using the location detection component, the generating step, and the conveying step as an individual carrying the mobile device moves from one location to another to assure the presence information used to ascertain the proximate communication device is current.

6. The method of claim 1, wherein the communication is a real-time communication, wherein the ascertained communication device is a telephone associated with a telephone number, wherein the telephone number is not specified by the originator.

7. The method of claim 1, wherein the ascertained device is a public, line-based telephone.

8. The method of claim 1, wherein the communication is at least one of a facsimile message, a text message, and an email message.

9. The method of claim 1, further comprising:
notifying the target recipient of the communication, wherein said notification has a characteristic attribute associated specifically with the target recipient.

10. The method of claim 9, wherein the characteristic attribute is at least one of a characteristic ring-tone, synthesized speech identifying the target recipient by name, and a visually presented message identifying the target recipient by name.

11. The method of claim 1, wherein the presence information is managed by a presence server, wherein said presence server is configured to accept, manage, and distribute presence information using Session Initiation Protocol (SIP) based messages and in conformance with an Internet Engineering Task Force (IETF) based standard, and wherein the presence server provides operations for PUBLISH, SUBSCRIBE, and NOTIFY.

12. A communication system comprising:
a presence information data store configured to be continuously updated with information specifying an identity and a geographical location of a plurality of people, said presence information data store further comprising device records indicating a location and a contact identifier for a plurality of communication devices; and
a communication service provider configured to accept communication attempts from an originator directed towards a target recipient, to determine a geographical location of the target recipient by querying the presence information data store, to determine a proximate communication device by comparing the device records against the determined geographical location, to send a communication initiation to the proximate communication device, and to establish a communication between the originator and the proximate communication device once the communication initiation has been accepted.

13. The communication system of claim 12, further comprising:
a presence server configured to accept, manage, and distribute presence information using Session Initiation Protocol (SIP) based messages and in conformance with an Internet Engineering Task Force (IETF) based standard, and wherein the presence server provides operations for PUBLISH, SUBSCRIBE, and NOTIFY, wherein the presence information data store is maintained by the presence server.

14. The communication system of claim 12, further comprising:
a notifier configured to notify the target recipient of the communication, which the target recipient is able to accept via the proximate communication device, wherein the notifier utilizes a characteristic attribute associated specifically with a characteristic attribute corresponding to the target recipient, wherein said characteristic attribute is at least one of a characteristic ring-tone, synthesized speech identifying the target recipient by name, and a visually presented message identifying the target recipient by name.

15. The communication system of claim 12, wherein the proximate communication device is coupled to at least one wireless transceiver associated with the target recipient, wherein the wireless transceiver is used to provide output from the proximate communication device to the target recipient and is used to receive input from the target recipient that is relayed to the proximate communication device as input.

16. The communication system of claim 12, wherein the proximate communication device is a telephone accessible by any proximate individual, and wherein said telephone is not specifically designated by the originator.

17. The communication system of claim 12, further comprising:
a plurality of beacon detectors configured to accept identifying messages from mobile identification beacons carried by proximately located people; and
at least one transceiver linked to the beacon detectors, wherein presence information derived from data obtained from the beacon detectors is conveyed by the transceiver over a network to be stored in the presence information data store.

18. A communication method comprising:
repetitively conveying presence information to a service provider to continuously update a current location of a person identified within the presence information;
detecting a communication attempt directed towards the person;
determining a communication device proximate to the person based upon the presence information, wherein said communication device is accessible by any proximate individual, and wherein said communication device is not specifically designated by an originator of the communication attempt;
presenting a notification of the communication attempt in an environment proximate to the determined communication device; and
establishing the communication responsive to the person answering the notification by activating the communication device.

19. The method of claim 18, wherein the communication is a telephone call, wherein the determined communication device is a telephone, wherein the detecting, determining, conveying, and establishing steps are performed by a telephone carrier.

20. The method of claim 18, further comprising:
determining a second communication attempt directed towards the person;
determining a second communication device that is now near the person, wherein the original communication device is no longer proximate to the person as determined from the presence information;
presenting a second notification of the second communication attempt to an environment proximate to the second communication device; and
establishing the second communication responsive to the person answering the second notification by activating the second communication device.
